(19) United States
(12) Patent Application Publication
(10) Pub. No.: US 2023/0041776 A1
(43) Pub. Date: Feb. 9, 2023

(54) PNEUMATIC TIRE

(71) Applicant: The Yokohama Rubber Co., LTD., Tokyo (JP)

(72) Inventor: Yasuhiro TAKAHASHI, Kanagawa (JP)

(21) Appl. No.: 17/904,760

(22) PCT Filed: Feb. 27, 2020
(86) PCT No.: PCT/JP2020/008139

§ 371 Date: Aug. 22, 2022

(51) Int. Cl. B60C 9/18; B60C 9/20

(52) U.S. Cl. CPC B60C 9/1835; B60C 9/20; B60C 2009/1842; B60C 2009/1857; B60C 2009/2035; B60C 2009/2038; B60C 2009/2083

(57) ABSTRACT

In a pneumatic tire, a belt cover disposed on an outer side in a radial direction of a belt layer includes a cover portion having a width equal to a width of the belt cover, and edge cover portions layered on the cover portion at two locations on both sides of the cover portion. Of the edge cover portions at the two locations, one of the edge cover portions is located on a radially inner side of the cover portion, and the other of the edge cover portions is located on a radially outer side of the cover portion. The belt cover is a single strip material having a band-like shape spirally wound about a tire rotation axis, and the cover portion at least partially includes a portion where circumferential portions adjacent in the width direction of the strip material that is spirally wound overlap in the radial direction.

### TECHNICAL FIELD

The present technology relates to a pneumatic tire.

### BACKGROUND ART

Some pneumatic tires in the related art have achieved desired performance by devising a member disposed on an outer side in a tire radial direction of a belt layer. For example, in an automotive radial tire described in Japan Unexamined Patent Publication No. H02-296507 A, a cored rubber strip is wound up at a pitch smaller than the width thereof with portions in the width of adjacent coils overlapped with each other, and thus the time to wind up the cored rubber strip is reduced. Further, in a pneumatic radial tire described in Japan Unexamined Patent Publication No. 2004-338502 A, a center cover layer is formed by butt-winding a strip material, and an edge cover layer is formed by wrapping the strip material, and thus uniformity of the tire is improved without the effect of reduction in noise due to a belt cover layer or improvement of high-speed durability.

Furthermore, in a pneumatic tire described in Japan Patent No. 6235859 B, a first band cord and a second band cord having the number of twists different from the number of twists of the first band cord are arranged on a band strip, and the first band cord and the second band cord are spirally wound on an outer side in a tire radial direction of a belt layer to be layered. Accordingly, high-speed durability is improved. Additionally, in a pneumatic tire described in Japan Unexamined Patent Publication No. 2010-064644 A, by circumferentially winding up a ribbon-shaped strip material between a tread portion and a belt layer, a belt reinforcing layer is disposed, and the belt reinforcing layer is configured in three layers on a tire equator portion. Accordingly, breaking energy is ensured while an increase in weight is suppressed.

In recent years, with vehicle performance increasing, high-speed performance has tended to be demanded in pneumatic tires. In order to ensure the high-speed performance, for example, it has been necessary to provide a belt cover that restrains a belt layer from the outer side in the tire radial direction by winding a plurality of strip materials on an outer side in a tire radial direction, ensuring strength for achieving the high-speed performance. However, in cases where the strength for achieving the high-speed performance has been ensured by winding the plurality of strip materials on the outer side in the tire radial direction of the belt layer to form the belt cover, productivity during manufacturing has been reduced. Accordingly, it has been very difficult to ensure the high-speed performance while suppressing a reduction in productivity.

### SUMMARY

The present technology provides a pneumatic tire that can provide high-speed performance and productivity in a compatible manner.

A pneumatic tire according to an embodiment of the present technology includes: a belt layer disposed in a tread portion; and a belt cover disposed on an outer side in a tire radial direction of the belt layer. The belt cover includes a full cover portion having a width in a tire width direction being equal to a width in the tire width direction of the belt cover and edge cover portions layered on the full cover portion at two locations on both sides in the tire width direction of the full cover portion. Of the edge cover portions at the two locations, one of the edge cover portions is located on an inner side in the tire radial direction of the full cover portion, and an other of the edge cover portions is located on an outer side in the tire radial direction of the full cover portion. The belt cover is formed by spirally winding a single strip material having a band-like shape about a tire rotation axis, and the full cover portion at least partially includes a portion where circumferential portions adjacent in the tire width direction of the strip material that is spirally wound overlap in the tire radial direction.

Further, in the pneumatic tire described above, the full cover portion preferably includes a full cover center portion straddling a tire equatorial plane, and full cover shoulder portions, each of which is located on an outer side in the wire width direction of the full cover center portion, the circumferential portions adjacent in the tire width direction of the strip material being spirally wound while being overlapped in the tire radial direction in the full cover shoulder portion.

Furthermore, in the pneumatic tire described above, the belt cover preferably has a relationship between a width Ws of the strip material and a wrapping pitch Ps that is Ps/Ws=1 in the edge cover portion, that is in a range 0.5≤Ps/Ws≤1 in the full cover center portion, and that is Ps/Ws=0.5 in the full cover shoulder portion.

Additionally, in the pneumatic tire described above, the full cover shoulder portion preferably has a width in the tire width direction that is in a range 0.05≤Wfs/Wc≤0.3 with respect to a width We in the tire width direction of the belt cover.

Further, in the pneumatic tire described above, the strip material preferably includes a plurality of cords, and the number of cords is preferably within a range of 8 or more and 16 or less.

Furthermore, in the pneumatic tire described above, the belt cover preferably has a width in the tire width direction that is greater than a width in the tire width direction of the belt layer, and covers the belt layer from the outer side in the tire radial direction.

The pneumatic tire according to the present technology has the effect of providing high-speed performance and productivity in a compatible manner.

### BRIEF DESCRIPTION OF DRAWINGS

FIG. 1 is a meridian cross-sectional view illustrating a main portion of a pneumatic tire according to a first embodiment.

FIG. 2 is a schematic diagram illustrating the configuration of a belt cover illustrated in FIG. 1.

FIG. 3 is a detailed view of portion A of FIG. 2.

FIG. 4 is a detailed view of portion B of FIG. 2.

FIG. 5 is a schematic diagram illustrating the configuration of the belt cover of the pneumatic tire according to a second embodiment.

FIG. 6 is a table indicating the results of performance tests of pneumatic tires.

### DETAILED DESCRIPTION

Pneumatic tires according to embodiments of the present technology are described in detail below with reference to the drawings. However, the present technology is not limited to the embodiment. Constituents of the following embodiments include elements that can be substituted and easily conceived of by a person skilled in the art or that are essentially identical.

### First Embodiment

### Pneumatic Tire

In the following description, the term “tire radial direction” refers to a direction orthogonal to the tire rotation axis (not illustrated) which is a rotation axis of a pneumatic tire 1, the term “inner side in the tire radial direction” refers to a side toward the tire rotation axis in the tire radial direction, and the term “outer side in the tire radial direction” refers to a side away from the tire rotation axis in the tire radial direction. The term “tire circumferential direction” refers to a circumferential direction with the tire rotation axis as a center axis. Additionally, the term “tire width direction” refers to a direction parallel with the tire rotation axis, the term “inner side in the tire width direction” refers to a side toward a tire equatorial plane (tire equatorial line) CL in the tire width direction, and the term “outer side in the tire width direction” refers to a side away from the tire equatorial plane CL in the tire width direction. The term “tire equatorial plane CL” refers to a plane that is orthogonal to the tire rotation axis and that runs through the center of the tire width of the pneumatic tire 1. The tire equatorial plane CL aligns, in a position in the tire width direction, with a center line in the tire width direction corresponding to a center position of the pneumatic tire 1 in the tire width direction. The tire width is the width in the tire width direction between portions located on the outermost sides in the tire width direction, or in other words, the distance between the portions that are the most distant from the tire equatorial plane CL in the tire width direction. “Tire equator line” refers to a line in the tire circumferential direction of the pneumatic tire 1 that lies on the tire equatorial plane CL.

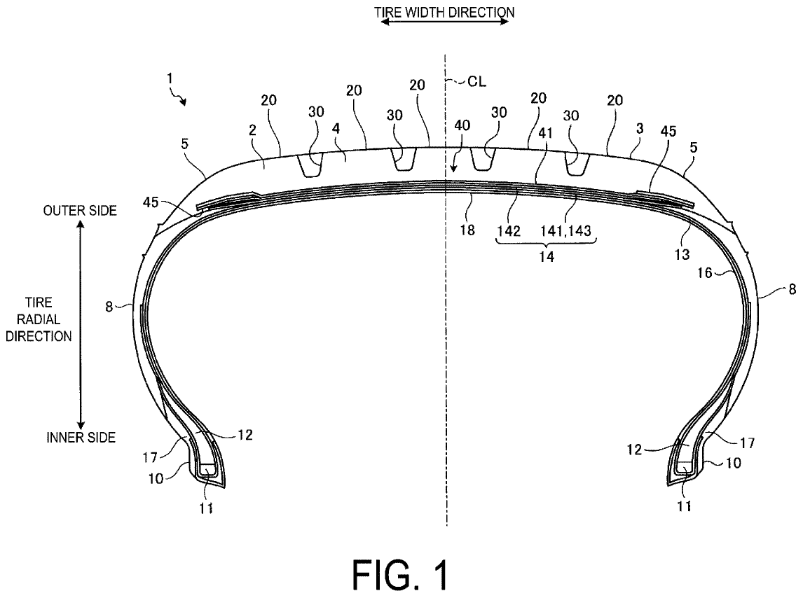

FIG. 1 is a meridian cross-sectional view illustrating a main portion of the pneumatic tire 1 according to a first embodiment. In the pneumatic tire 1 according to the first embodiment, as viewed in a tire meridian cross-section, a tread portion 2 extending in the tire circumferential direction and having an annular shape is disposed at a portion on the outermost side in the tire radial direction. The tread portion 2 includes a tread rubber layer 4 formed of a rubber composition. Additionally, a surface of the tread portion 2, that is, a portion that comes into contact with road surfaces during traveling of a vehicle (not illustrated) on which the pneumatic tires 1 are mounted is formed as a road contact surface 3, and the road contact surface 3 forms a portion of a contour of the pneumatic tire 1. A plurality of circumferential grooves 30 extending in the tire circumferential direction are formed in the ground contact surface 3 in the tread portion 2, and a plurality of lug grooves (not illustrated) extending in the tire width direction are formed. A plurality of land portions 20 are defined by the circumferential grooves 30 and the lug grooves on the surface of the tread portion 2.

Note that the circumferential groove 30 may linearly extend in the tire circumferential direction, or may be disposed in a wave-like shape or a zigzag shape waving in the tire width direction while extending in the tire circumferential direction. Likewise, the lug groove may extend linearly in the tire width direction, may be inclined in the tire circumferential direction while extending in the tire width direction, or may be bent or curved in the tire circumferential direction while extending in the tire width direction.

Shoulder portions 5 are located at both outer side ends of the tread portion 2 in the tire width direction, and a pair of sidewall portions 8 are disposed on inner sides in the tire radial direction of the shoulder portions 5. In other words, the pair of sidewall portions 8 are disposed on both sides in the tire width direction of the tread portion 2. The sidewall portions 8 are thus formed from outermost exposed portions of the pneumatic tire 1 in the tire width direction.

Bead portions 10 are respectively disposed on inner sides in the tire radial direction of the pair of sidewall portions 8. The bead portions 10 are disposed at two sections on both sides of the tire equatorial plane CL. In other words, a pair of the bead portions 10 are disposed on both sides in the tire width direction of the tire equatorial plane CL. Additionally, a bead core 11 is disposed in each of the bead portions 10, and a bead filler 12 is disposed on an outer side in the tire radial direction of the bead core 11. The bead core 11 is an annular member formed in an annular shape by bundling bead wires which are steel wires. The bead filler 12 is a rubber member disposed on the outer side in the tire radial direction of the bead core 11.

A belt layer 14 is disposed in the tread portion 2. The belt layer 14 is formed by a multilayer structure in which a plurality of belts 141, 142 are layered, and the two layers of the belts 141, 142 are layered in the present first embodiment. The belts 141, 142 constituting the belt layer 14 are formed by rolling and covering, with coating rubber, a plurality of belt cords made of steel or an organic fiber material, such as polyester, rayon, or nylon, and a belt angle defined as an inclination angle of the belt cords with respect to the tire circumferential direction is within a predetermined range (for example, of 20° or more and 55° or less). Furthermore, the belt angles of the two layers of the belts 141, 142 differ from each another. Accordingly, the belt layer 14 is configured as a so-called crossply structure in which the two layers of the belts 141, 142 are layered with the inclination directions of the belt cords intersecting with each another. In other words, the two layers of the belts 141, 142 are provided as a so-called pair of cross belts obtained by disposing the belt cords of the respective belts 141, 142 in a mutually intersecting direction.

A belt cover 40 is disposed on an outer side in the tire radial direction of the belt layer 14. The belt cover 40 is disposed on the outer side in the tire radial direction of the belt layer 14 to cover the belt layer 14 in the tire circumferential direction. The belt cover 40 is provided as a reinforcing layer that reinforces the belt layer 14. The belt cover 40 has a width in the tire width direction, which is greater than a width in the tire width direction of the belt layer 14, and covers the belt layer 14 from the outer side in the tire radial direction. Accordingly, the belt cover 40 is disposed over the entire area in the tire width direction in which the belt layer 14 is disposed, and covers end portions in the tire width direction of the belt layer 14. The tread rubber layer 4 included in the tread portion 2 is disposed on an outer side in the tire radial direction of the belt cover 40 in the tread portion 2.

Additionally, the belt cover 40 includes a full cover portion 41 having a width in the tire width direction that is equal to the belt cover 40 in the width in the tire width direction, and edge cover portions 45 stacked on the full cover portion 41 at two respective locations on both sides of the full cover portion 41 in the tire width direction. Of the two edge cover portions 45, one edge cover portion 45 is located on the inner side of the full cover portion 41 in the tire radial direction, and the other edge cover portion 45 is located on the outer side of the full cover portion 41 in the tire radial direction.

A carcass layer 13 containing the cords of radial plies is continuously provided on an inner side in the tire radial direction of the belt layer 14 and on a side of the sidewall portion 8 close to the tire equatorial plane CL. Accordingly, the pneumatic tire 1 according to the present first embodiment is configured as a so-called radial tire. The carcass layer 13 has a single layer structure made of one carcass ply or a multilayer structure made of a plurality of carcass plies, and spans between the pair of bead portions 10 disposed on both sides in the tire width direction in a toroidal shape to form a framework of the tire.

Specifically, the carcass layer 13 is disposed from one to the other of the pair of bead portions 10 located on both sides in the tire width direction and is turned back toward the outer side in the tire width direction along the bead cores 11 at the bead portions 10, wrapping around the bead cores 11 and the bead fillers 12. The bead filler 12 is a rubber member disposed in a space in the outer side of the bead core 11 in the tire radial direction, the space being formed by folding the carcass layer 13 back at the bead portion 10. Moreover, the belt layer 14 is disposed on the outer side in the tire radial direction of a portion, located in the tread portion 2, of the carcass layer 13 spanning between the pair of bead portions 10. The carcass ply of the carcass layer 13 is made by coating, with coating rubber, and rolling a plurality of carcass cords made from steel or an organic fiber material such as aramid, nylon, polyester, or rayon. The plurality of carcass cords forming the carcass ply is disposed in parallel at an angle in the tire circumferential direction, the angle with respect to the tire circumferential direction being along a tire meridian direction.

At the bead portion 10, a rim cushion rubber 17 is disposed on an inner side in the tire radial direction and an outer side in the tire width direction of the bead core 11 and a turned back portion of the carcass layer 13, the rim cushion rubber 17 forming a contact surface of the bead portion 10 against the rim flange. Additionally, an innerliner 16 is formed along the carcass layer 13 on the inner side of the carcass layer 13 or on the inner portion side of the carcass layer 13 in the pneumatic tire 1. The innerliner 16 forms a tire inner surface 18 that is a surface on the inner side of the pneumatic tire 1.

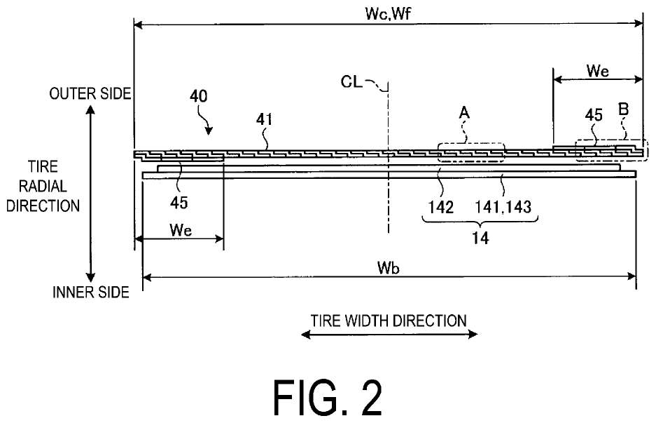

FIG. 2 is a schematic diagram illustrating the configuration of the belt cover 40 illustrated in FIG. 1. The belt cover 40 is formed by spirally winding a single band-like strip material 50 about the tire rotation axis. In other words, the belt cover 40 is formed by spirally winding the single strip material 50, and the full cover portion 41 and the edge cover portion 45 are also formed by the single continuous strip material 50. Of the full cover portion 41 and the edge cover portion 45 included in the belt cover 40, the full cover portion 41 at least partially includes a portion where circumferential portions adjacent in the tire width direction of the strip material 50 that is spirally wound overlap in the tire radial direction.

In the first embodiment, all portions of the strip material 50, which form the full cover portion 41, are spirally wound such that the circumferential portions adjacent in the tire width direction of the strip material 50 are overlapped with each other in the tire radial direction with a width approximately ½ of the width of the strip material 50. Consequently, the full cover portion 41 is formed substantially in two layers of the strip material 50. Meanwhile, in a portion of the strip material 50, which forms the edge cover portion 45, the circumferential portions adjacent in the tire width direction of the strip material 50 spirally wound are disposed side by side in the tire width direction without being overlapped with each other in the tire radial direction. Consequently, the edge cover portion 45 is formed in one layer of the strip material 50.

As a result, the belt cover 40 included in the pneumatic tire 1 according to the first embodiment is configured such that the strip material 50 is formed in two layers in a portion other than a portion in the tire width direction in which the edge cover portion 45 is disposed, that is, in a portion formed only by the full cover portion 41. Also, in a portion in which the edge cover portion 45 is disposed, that is, in a portion in which the full cover portion 41 and the edge cover portion 45 are layered, the strip material 50 is disposed in three layers.

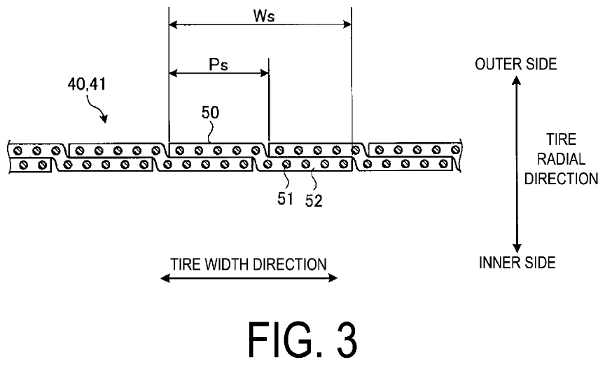

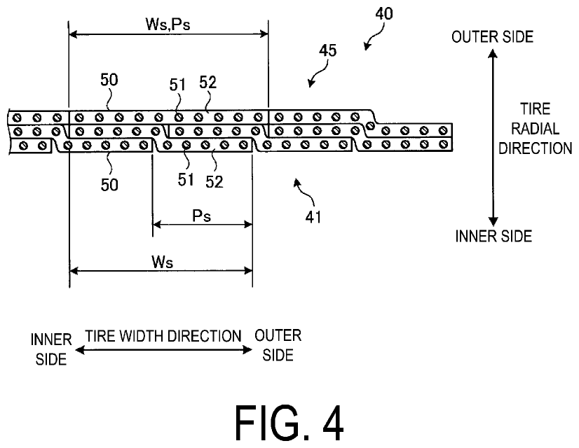

FIG. 3 is a detailed view of portion A of FIG. 2. FIG. 4 is a detailed view of portion B of FIG. 2. A portion of the strip material 50 in which the circumferential portions adjacent in the tire width direction are overlapped with each other in the tire radial direction will be described in detail. A portion of the strip material 50, which is located from the center region to one side in the width direction, is located on an outer side in the tire radial direction of the circumferential portion adjacent in the same direction in the width direction of the strip material 50. Meanwhile, a portion of the strip material 50, which is located from the center region to the other side in the width direction of the strip material 50, is located on an outer side in the tire radial direction of the circumferential portion adjacent in the same direction in the width direction of the strip material 50.

In other words, a portion of the strip material 50, which is located from the center region to one side in the width direction, is layered on the outer side in the tire radial direction of the circumferential portion adjacent in the width direction of the strip material 50, and a portion of the strip material 50, which is located from the center region to the other side in the width direction, is layered on the inner side in the tire radial direction of the circumferential portion adjacent on the different side in the width direction of the strip material 50. In other words, both sides of the strip material 50, which border the center region in the width direction, are layered at different circumferential portions of the strip material 50 in different layered forms. As a result, the strip material 50 is spirally wound with the shape in the tire meridian shaped like a crank shape.

In the belt cover 40 formed by winding the strip material 50, the relationship between a width Ws of the strip material 50 and a wrapping pitch Ps is in the range Ps/Ws=0.5±0.1 in the full cover portion 41, and is in the range Ps/Ws=1±0.1 in the edge cover portion 45. In other words, the relationship between the width Ws of the strip material 50 and the wrapping pitch Ps is substantially Ps/Ws=0.5 in the full cover portion 41, and is substantially Ps/Ws=1 in the edge cover portion 45.

Note that in FIGS. 3 and 4, the width Ws of the strip material 50 located in the full cover portion 41 is indicated by a width in a state where the shape in the tire meridian cross-section obtained by layering the adjacent circumferential portions is shaped like a crank shape; however, the width in a planar state without bending the strip material 50 is preferably used as the width Ws of the strip material 50. Additionally, the width of the strip material 50 is preferably within the range of 8 mm or more and 12 mm or less.

The strip material 50 forming the belt cover 40 includes a plurality of cords 51. The cords 51 included in the strip material 50 extend in the extension direction of the strip material 50, and a plurality of the cords 51 are disposed side by side in the width direction of the strip material 50. Further, the number of cords 51 included in the strip material 50 is within the range of 8 or more and 16 or less. Accordingly, when the belt cover 40 is represented by the number of ends, which is the number of cords 51 driven per 50 mm, the number of ends is in the range of 40/50 mm or more and 70/50 mm or less.

Furthermore, the cords 51 included in the strip material 50 each have a diameter in the range of 0.4 mm or more and 0.6 mm or less. By covering, with a coating rubber 52, the plurality of cords 51 disposed side by side as just described, the strip material 50 is formed.

The cord included in the strip material 50 of the belt cover 40 is made of, for example, steel or an organic fiber material such as polyester, rayon, or nylon. In the strip material 50 spirally wound about the tire rotation axis, an inclination angle of the cord 51 with respect to the tire circumferential direction is in the range of 0° or larger and 1° or smaller.

The belt cover 40 formed as just described is configured such that a width Wc in the tire width direction is in the range of 100% or more and 115% or less of a width Wb in the tire width direction of the belt layer 14. In this case, the width Wb in the tire width direction of the belt layer 14 is the width Wb in the tire width direction of a widest belt 143 that is a belt with the widest width in the tire width direction of the plurality of belts 141, 142 included in the belt layer 4. Additionally, the edge cover portions 45 at two locations are respectively configured such that a width We in the tire width direction is in the range of 5% or more and 30% or less of the width Wc in the tire width direction of the belt cover 40. Meanwhile, the full cover portion 41 has a width Wf in the tire width direction that is equal to the width Wc of the belt cover 40 in the tire width direction.

### Method for Manufacturing Pneumatic Tire

Next, the manufacturing method for the pneumatic tire 1 according to the first embodiment will be described. To manufacture the pneumatic tire 1, first, processing is performed on each of the members constituting the pneumatic tire 1, and the processed members are assembled. In other words, the rubber members such as the tread rubber layer 4 and each of the members such as the bead core 11, the carcass layer 13, the belt layer 14, and the belt cover 40 are processed and the processed members are assembled. Of these members, the belt cover 40 is disposed on the outer side in the tire radial direction of the belt layer 14 by spirally winding the band-like strip material 50 on the outer side in the tire radial direction of the belt layer 14 about the tire rotation axis.

By spirally winding the single strip material 50 with the use of the single strip material 50, the belt cover 40 is formed. In winding the strip material 50, of the edge cover portions 45 at two locations included in the belt cover 40, winding is started from a portion forming the edge cover portion 45 on the inner side in the tire radial direction of the full cover portion 41. Specifically, the strip material 50 is wound from a position corresponding to an end portion on the inner side in the tire width direction of the edge cover portion 45, and is wound spirally toward the outer side in the tire width direction. At that time, the strip material 50 is wound so as to butt the circumferential portions adjacent in the tire width direction as much as possible without overlapping the circumferential portions adjacent in the tire width direction.

The strip material 50 is wound to a position further on the outer side in the tire width direction than the belt layer 14 by being spirally wound toward the outer side in the tire width direction. Thereafter, the winding direction in the tire width direction of the strip material 50 is folded back, and the strip material 50 is wound toward the outer side in the tire radial direction of the winding-finished portion of the strip material 50. As just described, the edge cover portion 45 of the belt cover 40 is formed from the winding start position of the strip material 50 to the position at which the winding direction in the tire width direction of the strip material 50 is folded back.

The winding direction in the tire width direction of the strip material 50 is folded back and the strip material 50 is wound toward the outer side in the tire radial direction of the edge cover portion 45. Then, the winding-finished portion of the strip material 50 is spirally wound toward the inner side in the tire width direction while the portions adjacent in the tire width direction are overlapped in the tire radial direction. As a result, the full cover portion 41 is formed on the outer side in the tire radial direction of the edge cover portion 45. A portion of the strip material 50, which forms the full cover portion 41 is obtained by spirally winding the strip material toward the inner side in the tire width direction while allowing the portions adjacent in the tire width direction to be overlapped in the tire radial direction, allowing to pass through the position of the tire equatorial plane CL, and then spirally winding the portions toward the outer side in the tire width direction. In other words, the strip material 50 is spirally wound on the outer side in the tire radial direction of the belt layer 14 from one end side toward the other end side in the tire width direction.

The strip material 50 is spirally wound toward opposite end sides of both end sides in the tire width direction of the belt layer 14 where the edge cover portions 45 have already been formed and is wound to positions further on the outer side in the tire width direction than the belt layer 14. Thereafter, the strip material 50 is wound toward the outer side in the tire radial direction of the winding-finished portion of the strip material 50. As just described, the full cover portion 41 of the belt cover 40 is formed from the position at which the strip material 50 is overlapped on the outer side in the tire radial direction of the edge cover portion 45 located on the inner side in the tire radial direction of the full cover portion 41, to the position at which the winding direction in the tire width direction of the strip material 50 is folded back on the opposite end side of the side where the edge cover portion 45 is located in the tire width direction.

The winding direction of the strip material 50 is folded back, and the strip material 50 is wound toward the outer side in the tire radial direction of the full cover portion 41. Then, the strip material 50 is further wound spirally toward the inner side in the tire width direction while the portions adjacent in the tire width direction are allowed to be butted without allowing the portions adjacent in the tire width direction to be overlapped. As a result, the edge cover portion 45 is formed on the outer side in the tire radial direction of the full cover portion 41. In other words, of the edge cover portions 45 at two locations in the belt cover 40, the edge cover portion 45 located on the outer side in the tire radial direction of the full cover portion 41 is formed.

As described above, the belt cover 40 is formed by spirally winding the single strip material 50 about the tire rotation axis toward the outer side in the tire radial direction of the belt layer 14, with the full cover portion 41 and the edge cover portions 45 at two locations being formed by the single strip material 50.

### Functions and Effects

In the event of mounting the pneumatic tire 1 according to the first embodiment on a vehicle, the pneumatic tire 1 is mounted on a rim wheel with the inside filled with air into an inflated state. When the vehicle on which the pneumatic tires 1 are mounted travels, the pneumatic tires 1 each rotate while, of the road contact surface 3 on the tread portion 2, the road contact surface 3 located at the bottom is in contact with the road surface. When the vehicle on which the pneumatic tires 1 are mounted travels on a dry road surface, the vehicle travels mainly by transmitting a driving force and a braking force to the road surface and generating a turning force by friction forces between the tread contact surfaces 3 and the road surface. Additionally, during traveling on wet road surfaces, water between the tread contact surface 3 and the road surface enters grooves such as the circumferential grooves 30 and the lug grooves, and the vehicle travels while the water between the tread contact surface 3 and the road surface is drained by the grooves. As a result, the tread contact surface 3 easily contacts the road surface, and the vehicle can travel by the friction force between the tread contact surface 3 and the road surface.

Additionally, a load due to a weight of a vehicle body, acceleration/deceleration, or turning is applied to the pneumatic tire 1 during traveling of the vehicle, and thus a load acts on the tread portion 2 in the tire radial direction. However, since the pneumatic tire 1 rotates, the load acting on the tread portion 2 acts while moving relatively in the tire circumferential direction. In particular, during high-speed travel, the pneumatic tire 1 rotates at a high speed, and thus, the load acting on the tread portion 2 acts while moving relatively in the tire circumferential direction at a high speed. Also, in a case where the pneumatic tire 1 rotates at a high speed, a large centrifugal force acts on the pneumatic tire 1, and an especially large centrifugal force acts on the tread portion 2 largely distant from the tire rotation axis. As a result, during high-speed traveling of the vehicle, the large load is applied to the tread portion 2 but can be received by the belt layer 14 and the belt cover 40 that are disposed in the tread portion 2.

In this time, the belt cover 40 is formed by spirally winding the strip material 50, and the full cover portion 41 of the belt cover 40 includes a portion where the circumferential portions adjacent in the tire width direction of the strip material 50 overlap in the tire radial direction. The circumferential portions adjacent in the tire width direction of the strip material 50 are formed overlapped as just described, and thus the belt cover 40 disposed on the outer side in the tire radial direction of the belt layer 14 is formed substantially in two layers in the overlapping portion of the strip material 50. As a result, the belt cover 40 can ensure rigidity and can ensure strength with respect to the tire circumferential direction and the tire radial direction, and thus can ensure a restricting force with respect to the belt layer 14. Accordingly, when the pneumatic tire 1 rotates at a high speed during high-speed traveling of the vehicle, the pneumatic tire 1 can ensure the strength to the load acting on the tread portion 2, and the high-speed performance of the pneumatic tire 1 can be ensured.

Additionally, since the belt cover 40 is formed by spirally winding the single strip material 50, the strength of the entire belt cover 40 can be made uniform compared with a case where the belt cover 40 is formed by a plurality of strip materials 50. In other words, the strip materials 50 may differ slightly in the number of cords 51 and the diameters and arrangement configuration of the cords 51 of each strip material 50, and accordingly, in a case where the belt cover 40 is formed by the plurality of strip materials 50, the different strip materials 50 forming the belt cover 40 may have different strength levels. In this case, the different strip materials 50 forming the belt cover 40 may also have different restricting force levels with respect to the belt layer 14. Accordingly, conicity that indicates a turning force when the pneumatic tire 1 turns in a direction oblique to the tire rotation axis may be deteriorated. In contrast, in a case where the belt cover 40 is formed by the single strip material 50, non-uniformity of the strength of the belt cover 40 due to the different number of cords 51, different diameters of the cords 51, or the like of the different strip materials 50 can be suppressed. As a result, the deterioration of conicity can be suppressed.

Additionally, when the belt cover 40 is formed by spirally winding the strip material 50, the length direction of the strip material 50 affects the radial force variation (RFV) that indicates a variation in force in the tire radial direction on the tire circumference; however, the end portion of the strip material 50 is two times the number of strip materials 50. Accordingly, when the number of strip materials 50 increases, the end portions of the strip material 50 that affect the RFV also increase, which may easily deteriorate the RVF. However, when the belt cover 40 is formed by the single strip material 50, the number of end portions of the strip material 50 can be minimized. As a result, deterioration of the RFV can be suppressed. In other words, when the belt cover 40 is formed by the single strip material 50, the number of end portions in the length direction of the strip material 50 can be minimized. As a result, the uniformity of the pneumatic tire 1 can be improved, and deterioration of the RFV can be suppressed.

Additionally, in layering the strip material 50 to ensure the strength of the belt cover 40, the plurality of strip materials 50 are used. In such a case, after the strip material 50 relatively located on the inner side in the tire radial direction is wound, the strip material 50 located on the outer side in the tire radial direction of the former strip material 50 is wound. In this case, the time to wind the strip material 50 at the time of manufacturing the pneumatic tire 1 may be increased; however, in the first embodiment, in layering the strip material 50, the circumferential portions adjacent in the tire width direction of the single strip material 50 are layered in the tire radial direction. Accordingly, the time to wind the strip material 50 in layering the strip material 50 to form the belt cover 40 can be reduced, and productivity in layering the strip material 50 to form the belt cover 40 can be improved. As a result, high-speed performance and productivity can be provided in a compatible manner.

Further, in the belt cover 40, the relationship between the width Ws of the strip material 50 and the wrapping pitch Ps is Ps/Ws=0.5 in the full cover portion 41 and is Ps/Ws=1 in the edge cover portion 45. Accordingly, the strip material 50 can be disposed in two layers in the full cover portion 41, and the strip material 50 can be disposed in one layer in the edge cover portion 45. Consequently, in a region near the center in the tire width direction, the strip material 50 can be disposed in two layers, and the strip material 50 can be disposed in three layers in a region closer to the shoulder portion 5. As a result, the strength of the entire range in which the belt layer 14 is disposed in the tire width direction can be ensured. In addition, in a location closer to the shoulder portion 5 in the tread portion 2 on which a large load is likely to act, the strength against the load acting on the tread portion 2 can be more reliably ensured. As a result, high-speed performance can be more reliably improved.

Additionally, the strip material 50 includes the plurality of cords 51, and the number of cords 51 is within the range of 8 or more and 16 or less. As a result, the restricting force of the belt cover 40 with respect to the belt layer 14 can be ensured while the easiness in spirally winding the strip material 50 in an overlapped manner is ensured. In other words, in a case where the number of cords 51 of the strip material 50 is less than 8, the number of cords 51 is too small, and thus it may be difficult to ensure the strength of the strip material 50. In this case, it is difficult to ensure the strength of the belt cover 40 formed by spirally winding the strip material 50 on the outer side in the tire radial direction of the belt layer 14, and thus it may be difficult to ensure the restricting force of the belt cover 40 with respect to the belt layer 14. Also, in a case where the number of cords 51 of the strip material 50 is greater than 16, the number of cords 51 is too large, and thus the strength of the strip material 50 may be too high. In this case, it is difficult for the strip material 50 to deform in a crank-like shape in laying both sides of the strip material 50, which border the center region in the width direction, at the different circumferential portions in different layered forms. As a result, it may be difficult to spirally wind the strip material 50 in an overlapped manner.

In contrast, in a case where the number of cords 51 of the strip material 50 is within the range of 8 or more and 16 or less, the strength of the strip material 50 can be appropriately sized. Consequently, the restricting force of the belt cover 40 with respect to the belt layer 14 can be ensured while the easiness in spirally winding the strip material 50 in an overlapped manner is ensured. As a result, high-speed performance and productivity can be more reliably provided in a compatible manner.

Additionally, the belt cover 40 has the width We in the tire width direction greater than the width Wb in the tire width direction of the belt layer 14, and covers the belt layer 14 from the outer side in the tire radial direction. Accordingly, the entire region in the tire width direction of the belt layer 14 can be more reliably restrained by the belt cover 40 from the outer side in the tire radial direction. Consequently, when the pneumatic tire 1 rotates at a high speed during high-speed traveling of the vehicle, the pneumatic tire 1 can more reliably ensure the strength to the load acting on the tread portion 2. As a result, high-speed performance can be more reliably improved.

### Second Embodiment

The pneumatic tire 1 according to a second embodiment has a configuration substantially similar to that of the pneumatic tire 1 according to the first embodiment, but is characterized in that the full cover portion 41 of the belt cover 40 includes a portion in which the strip material 50 is layered and a portion in which the strip material 50 is not layered. Because the other configurations are identical to those of the first embodiment, descriptions thereof will be omitted and the identical reference numerals are used.

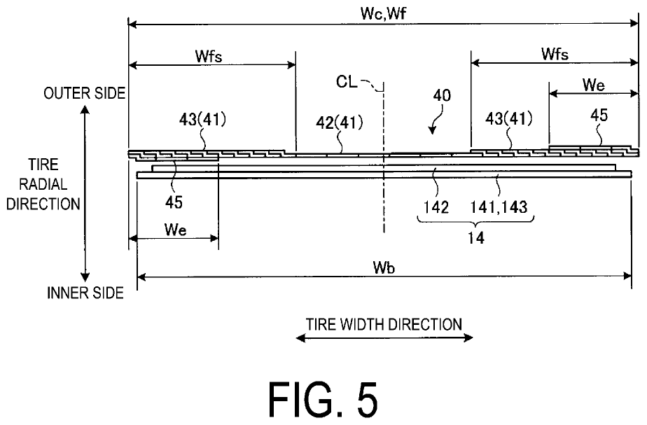

FIG. 5 is a schematic diagram illustrating the configuration of the belt cover 40 of the pneumatic tire 1 according to the second embodiment. In the pneumatic tire 1 according to the second embodiment, the belt cover 40 formed by spirally winding the single strip material 50 on the outer side in the tire radial direction of the belt layer 14 about the tire rotation axis is disposed in the same manner as in the pneumatic tire 1 according to the first embodiment. Additionally, in the pneumatic tire 1 according to the second embodiment, unlike the first embodiment, the full cover portion 41 included in the belt cover 40 includes a portion in which the circumferential portions adjacent in the tire width directions of the strip material 50 are overlapped in the tire radial direction and a portion in which the circumferential portions adjacent in the tire width directions of the strip material 50 are not overlapped in the tire radial direction.

Specifically, the full cover portion 41 of the belt cover 40 included in the pneumatic tire 1 according to the second embodiment includes a full cover center portion 42 straddling the tire equatorial plane CL and a full cover shoulder portions 43 each located on an outer side in the tire width direction of the full cover center portion 42. The full cover shoulder portions 43 are disposed on both sides in the tire width direction of the full cover center portion 42. Of these portions, in the full cover shoulder portion 43, the circumferential portions adjacent in the tire width direction of the strip material 50 are spirally wound while being overlapped in the tire radial direction. On the other hand, in the full cover center portion 42, the circumferential portions adjacent in the tire width direction of the strip material 50 are spirally wound and disposed side by side in the tire width direction while not being overlapped in the tire radial direction.

In other words, in the second embodiment, the belt cover 40 has a relationship between the width Ws of the strip material 50 and the wrapping pitch Ps, which is substantially Ps/Ws=1 in the full cover center portion 42 in the same manner as in the edge cover portion 45. In the full cover shoulder portion 43, the relationship is substantially Ps/Ws=0.5 in the same manner as in the full cover portion 41 of the first embodiment.

Also, as just described, of the full cover center portion 42 and the full cover shoulder portion 43 included in the full cover portion 41 of the belt cover 40, the full cover shoulder portion 43 has a width Wfs in the tire width direction, which is in the range 0.05≤Wfs/Wc≤0.30 with respect to the width We in the tire width direction of the belt cover 40.

In the pneumatic tire 1 according to the second embodiment, the full cover portion 41 of the belt cover 40 includes the full cover center portion 42 in which the strip material 50 is wound without being overlapped, and the full cover shoulder portions 43 in which the strip material 50 is wound in an overlapped manner. Accordingly, the restricting force of the belt cover 40 with respect to the belt layer 14 can be exhibited in a more appropriate position. In other words, a large load easily acts on the tread portion 2 in a location closer to the shoulder portion 5 during traveling of the vehicle. However, the full cover shoulder portions 43 located on both sides in the tire width direction of the full cover center portion 42 are provided by winding the strip material 50 in an overlapped manner. As a result, the strength of the location closer to the shoulder portion 5 can be ensured. Accordingly, high-speed performance can be improved.

Also, in the tread portion 2, the full cover center portion 42 on which a large load is unlikely to act compared with the location closer to the shoulder portion 5 and which is located near the center in the tire width direction is formed by winding the strip material 50 without overlapping. Accordingly, the time to wind the strip material 50 can be more reliably reduced. Consequently, productivity in forming the belt cover 40 by spirally winding the strip material 50 can be improved. As a result, high-speed performance and productivity can be more reliably provided in a compatible manner.

Further, the belt cover 40 has the relationship between the width Ws of the strip material 50 and the wrapping pitch Ps, which is Ps/Ws=1 in the full cover center portion 42, and in the full cover shoulder portion 43, the relationship is Ps/Ws=0.5. Accordingly, the strip material 50 can be disposed in one layer in the full cover center portion 42, and the strip material 50 can be disposed in two layers in the full cover shoulder portion 43. Consequently, the strip material 50 can be disposed in two layers in a region closer to the shoulder portion 5 in the full cover portion 41, and thus in a location closer to the shoulder portion 5 in the tread portion 2 on which a large load is likely to act, the strength against the load acting on the tread portion 2 can be more reliably ensured. Furthermore, in a region near the center in the tire width direction in the full cover portion 41, the strip material 50 can be disposed in one layer, and thus the time to wind the strip material 50 can be reduced in a location near the center on which a load acting on the tread portion 2 is relatively low. As a result, high-speed performance and productivity can be more reliably provided in a compatible manner.

In addition, the full cover shoulder portion 43 of the belt cover 40 has the width Wfs in the tire width direction, which is in the range 0.05≤Wfs/Wc≤0.30 with respect to the width Wc in the tire width direction of the belt cover 40. Accordingly, the strength of locations closer to both ends in the tire width direction of the belt cover 40 can be more reliably endured while the time to wind the strip material 50 is reduced. In other words, in a case where the width Wfs of the full cover shoulder portion 43 is Wfs/Wc<0.05 with respect to the width Wc of the belt cover 40, the width Wfs of the full cover shoulder portion 43 is too narrow, and thus it may be difficult to ensure the strength of the locations closer to both ends in the tire width direction of the belt cover 40. In this case, it may be difficult to ensure the strength in the location closer to the shoulder portion 5 in the tread portion 2. Moreover, in a case where the width Wfs of the full cover shoulder portion 43 is Wfs/Wc>0.30 with respect to the width Wc of the belt cover 40, the width Wfs of the full cover shoulder portion 43 is too wide, and thus the width of the full cover center portion 42 may be too narrow. In this case, the range of winding the strip material 50 in one layer becomes narrow, and thus it may be difficult to effectively reduce the time to wind the strip material 50.

In contrast, in a case where the width Wfs of the full cover shoulder portion 43 is within the range 0.05≤Wfs/Wc≤0.30 with respect to the width Wc of the belt cover 40, the strength of the locations closer to both ends in the tire width direction of the belt cover 40 can be more reliably ensured while the time to wind the strip material 50 is more reliably reduced. As a result, high-speed performance and productivity can be more reliably provided in a compatible manner.

### MODIFIED EXAMPLES

Additionally, in the pneumatic tire 1 according to the first embodiment described above, the relationship between the width Ws of the strip material 50 of the full cover portion 41 included in the belt cover 40 and the wrapping pitch Ps is Ps/Ws=0.5. In the pneumatic tire 1 according to the second embodiment, the relationship between the width Ws of the strip material 50 of the full cover center portion 42 and the wrapping pitch Ps is Ps/Ws=1. However, the relationship between the width Ws of the strip material 50 and the wrapping pitch Ps may be other than this. The relationship between the width Ws of the strip material 50 of the full cover portion 41 included in the belt cover 40 and the winding pitch Ps may include the first embodiment and the second embodiment, and the full cover center portion 42 may be in the range 0.5≤Ps/Ws≤1. In other words, the relationship between the width Ws of the strip material 50 of the belt cover 40 and the wrapping pitch Ps is Ps/Ws=1 in the edge cover portion 45, is in the range 0.5≤Ps/Ws≤1 in the full cover center portion 42, and may be Ps/Ws=0.5 in the full cover shoulder portion 43. The belt cover 40 is formed such that the relationship between the width Ws of the strip material 50 and the wrapping pitch Ps is in these ranges, and thus high-speed performance and productivity can be provided in a compatible manner.

### Examples

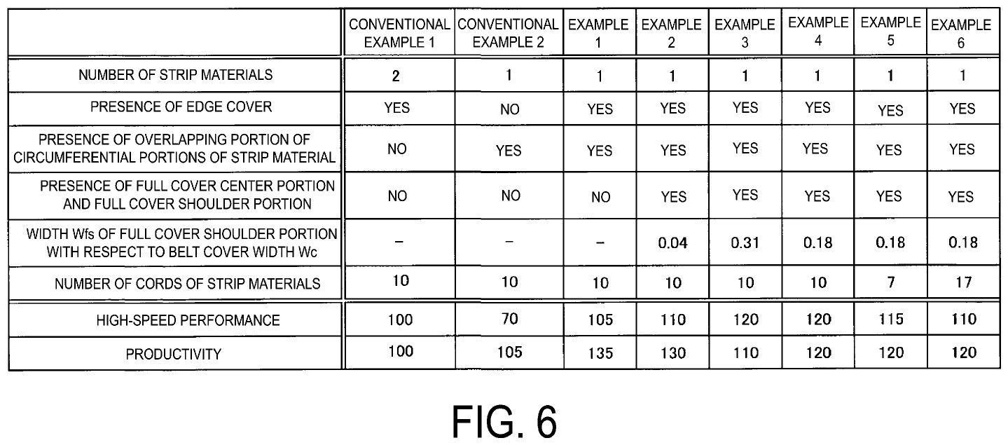

FIG. 6 is a table indicating the results of performance tests of pneumatic tires. Hereinafter, evaluation tests of performance of the pneumatic tire 1 described above performed on pneumatic tires of Conventional Examples and the pneumatic tires 1 according to the embodiments of the present technology will be described. For performance evaluation tests, tests on high-speed performance and productivity were performed.

The performance evaluation tests were performed by using the pneumatic tire 1 having a tire nominal size of 275/40R19 101Y specified by JATMA (The Japan Automobile Tyre Manufacturers Association, Inc. In the evaluation method for each test item, for high-speed performance, each test tire was mounted on a wheel having a rim size of 19×9.5, inflated to 320 kPa, mounted on an indoor drum testing machine (drum diameter of 1707 mm) complying with ECE (The United Nations Economic Commission for Europe) 30, and loaded with 80% of the load corresponding to the conditions of air pressure specified by ECE 30 at the speed of 81 km/h. The test was started at the speed of 260 km/h, the vehicle was driven with the speed increasing stepwise by 10 km/h every ten minutes until a failure occurred, and the travel distance was measured until a tire failure occurred. The evaluation results are expressed as index values with Conventional Example 1 being assigned the value of 100. Larger index values indicate superior high-speed durability. Particularly, the index value of 105 or more is high high-speed durability, which is preferable.

In addition, regarding productivity, the time required for winding the strip material 50 in a step of winding the strip material 50 during the manufacturing of the tires was measured. The productivity is expressed as index evaluations of a reciprocal of the measured time with Conventional Example 1 described below being assigned as 100. Larger index values indicate shorter winding time and higher productivity.

The performance evaluation tests were performed on eight types of pneumatic tires, which were pneumatic tires of Conventional Examples 1, 2 as examples of the conventional pneumatic tires and the pneumatic tires 1 according to the present technology of Examples 1 to 6. Of these tires, in the pneumatic tire of Conventional Example 1, the belt cover 40 is formed of the two strip materials 50 as in Japan Unexamined Patent Publication No. 2010-064644 A and does not include an overlapping portion of the circumferential portions of the strip material 50. Further, in the pneumatic tire of Conventional Example 2, the belt cover 40 is formed of the single strip material 50 as in Japan Patent No. 6235859 B. The belt cover 40 includes an overlapping portion of the circumferential portions of the strip material 50 but does not include the edge cover portions 45 layered on the full cover portion 41.

In contrast, in all of Examples 1 to 6 as examples of the pneumatic tire 1 according to the present technology, the belt cover 40 is formed by the single strip material 50, and the belt cover 40 includes an overlapping portion of the circumferential portions of the strip material 50 and includes the edge cover portions 45 at two locations layered on the full cover portion 41. In addition, the pneumatic tires 1 according to Examples 1 to 6 differ from each other in the presence of the full cover center portion 42 and the full cover shoulder portion 43, and the width Wfs of the full cover shoulder portion 43 with respect to the width We of the belt cover 40, and the number of cords 51 of the strip material 50.

As a result of performing the performance evaluation tests by using the pneumatic tires 1, it was revealed as indicated in FIG. 6 that compared with Conventional Examples 1, 2, the pneumatic tires 1 according to Examples 1 to 6 can improve high-speed performance while suppressing a decrease in productivity. In other words, the pneumatic tires 1 according to Examples 1 to 6 can provide high-speed performance and productivity in a compatible manner.

1. A pneumatic tire, comprising:
a belt layer disposed in a tread portion; and
a belt cover disposed on an outer side in a tire radial direction of the belt layer,
the belt cover comprising
a full cover portion having a width in a tire width direction being equal to a width in the tire width direction of the belt cover and
edge cover portions layered on the full cover portion at two locations on both sides in the tire width direction of the full cover portion,
of the edge cover portions at the two locations, one of the edge cover portions being located on an inner side in the tire radial direction of the full cover portion, and an other of the edge cover portions being located on an outer side in the tire radial direction of the full cover portion,
the belt cover being formed by spirally winding a single strip material having a band-like shape about a tire rotation axis, and
the full cover portion at least partially comprising a portion where circumferential portions adjacent in the tire width direction of the strip material that is spirally wound overlap in the tire radial direction.

2. The pneumatic tire according to claim 1, wherein the full cover portion comprises a full cover center portion straddling a tire equatorial plane, and full cover shoulder portions, each of which is located on an outer side in the wire width direction of the full cover center portion, the circumferential portions adjacent in the tire width direction of the strip material being spirally wound while being overlapped in the tire radial direction in the full cover shoulder portion.

3. The pneumatic tire according to claim 2, wherein the belt cover has a relationship between a width Ws of the strip material and a wrapping pitch Ps that is Ps/Ws=1 in the edge cover portion, that is in a range 0.5≤Ps/Ws≤1 in the full cover center portion, and that is Ps/Ws=0.5 in the full cover shoulder portion.

4. The pneumatic tire according to claim 2, wherein the full cover shoulder portion has a width in the tire width direction being in a range 0.05≤Wfs/Wc≤0.3 with respect to a width Wc in the tire width direction of the belt cover.

5. The pneumatic tire according to claim 1, wherein the strip material comprises a plurality of cords, and the number of cords is within a range of 8 or more and 16 or less.

6. The pneumatic tire according to claim 1, wherein the belt cover has a width in the tire width direction being greater than a width in the tire width direction of the belt layer, and covers the belt layer from the outer side in the tire radial direction.

7. The pneumatic tire according to claim 3, wherein the full cover shoulder portion has a width in the tire width direction being in a range 0.05≤Wfs/Wc≤0.3 with respect to a width Wc in the tire width direction of the belt cover.

8. The pneumatic tire according to claim 7, wherein the strip material comprises a plurality of cords, and the number of cords is within a range of 8 or more and 16 or less.

9. The pneumatic tire according to claim 8, wherein the belt cover has a width in the tire width direction being greater than a width in the tire width direction of the belt layer, and covers the belt layer from the outer side in the tire radial direction.
